(19) United States
(12) Patent Application Publication
(10) Pub. No.: US 2013/0023280 A1
(43) Pub. Date: Jan. 24, 2013

(54) Wireless Device Secure Tracking

(71) Applicants: Michael W. PADDON, Tokyo (JP); Joshua Rubin DAVIS, San Diego, CA (US); Craig W. NORTHWAY, Aspley (AU)

(72) Inventors: Michael W. PADDON, Tokyo (JP); Joshua Rubin DAVIS, San Diego, CA (US); Craig W. NORTHWAY, Aspley (AU)

(73) Assignee: QUALCOMM Incorporated, San Diego, CA (US)

(21) Appl. No.: 13/187,309

(22) Filed: Jul. 20, 2011

(51) Int. Cl. H04W 24/00

(52) U.S. Cl. 455/456.1

(57) ABSTRACT

A mobile device includes: a network interface configured to send messages toward, and receive messages from, a communication network wirelessly; and a message module independent of an OS and a BIOS of the mobile device, the message module being configured to produce and provide a location message to the network interface to be sent toward the communication network. The location message contains information that enables at least one of determination or estimation of a location of the mobile device and identification of the mobile device. The message module is configured to provide the location message to the transmitter without use of the operating system or the BIOS. The message module is configured to produce the location message based on a network communication message received at the mobile device through the network interface.

### BACKGROUND

With the proliferation of mobile, wireless communication devices, loss and theft of such devices is an ever-growing problem. Mechanisms have been developed to help with recovery of lost or stolen communication devices, and to inhibit access or use of devices that are lost or stolen. Examples of such mechanisms transmit identification and location signals on a regular basis or after being triggered, e.g., by receiving a request for such information, or inhibit operation of the device, or restrict access to information or functions of the device (e.g., requiring a password to access information or functions). The identification and location information can be used by the owner or law enforcement personnel to locate the device. Typically the security mechanisms that send information are installed in the operating system (OS) and/or the basic input/output system (BIOS), either temporarily or permanently, and communicate with a network interface to send the identification and location information. Thus, by disabling, removing, modifying, or replacing the OS or the BIOS, as appropriate, the tracking components can be defeated and the mobile device cannot be located using the tracking components. A system discussed in U.S. Pat. No. 7,546,639 uses a location detector to determine location of a device, and communicates the location through a network interface to a desired destination.

### SUMMARY

An example of a mobile device includes: a network interface configured to send messages toward, and receive messages from, a communication network wirelessly; and a message module, communicatively coupled to the network interface, independent of an operating system of the mobile device, and independent of a basic input/output system (BIOS) of the mobile device, the message module being configured to produce and provide a location message to the network interface to be sent toward the communication network; where the location message contains information that enables at least one of determination or estimation of a location of the mobile device and identification of the mobile device; where the message module is configured to provide the location message to the transmitter without use of the operating system or the BIOS; and where the message module is configured to produce the location message based on a network communication message received at the mobile device through the network interface.

Implementations of such a device may include one or more of the following features. The message module comprises a network interface card configured to produce the location message based on a network offer message received at the mobile device. The network interface card is configured to produce the location message based on a DHCP offer message received at the mobile device. The network interface card is configured to produce the location message in response to receipt of the network offer message. The network interface card is configured to produce the location message in response to receipt of a fixed quantity of the network offer messages received at the mobile device since a most-recent location message was produced by the message module. The network offer message comprises at least one IPv6 packet. The message module is configured to produce the location message based on a network associated with the network communication message. The location message includes at least one of satellite positioning system information, telecommunication cell information, or local wireless access point information. The message module consists of processing hardware and the network interface and the message module are integrated such that a communication link between the network interface and the message module is substantially inaccessible.

Another example of a mobile device includes: network communication means for wirelessly receiving network offer messages and for wirelessly transmitting a location message toward a communications network addressed to a predetermined destination; and message means for producing the location message, the message means and network communication means module being configured such that the location message is substantially inaccessible during communication from the message means to the network communication means; where a location of the mobile device can be at least one of determined or estimated from the location message; and where an identity of the mobile device can be determined from the location message.

Implementations of such a device may include one or more of the following features. The message means are for producing the location message independently of an operating system (OS) of the mobile device, and independently of a basic input/output system (BIOS) of the mobile device. The message means are configured to produce the location message based on a network offer message received at the mobile device by the network communication means. The message means are configured to produce the location message in response to receipt of a threshold number of the network offer messages at the mobile device since a most-recent location message was produced. The message means are configured to produce the location message in response to the network offer message being associated with a different network than a network associated with a previous network offer message corresponding to a most-recent location message produced by the message means.

An example of a method of providing mobile device tracking information includes: wirelessly receiving a network offer message at a mobile device; producing a location/identification message, from which an identity of the mobile device can be determined and a location of the mobile device can be at least one of determined or estimated, independently of an operating system and a basic input/output system of the mobile device; substantially inaccessibly providing the location/identification message to a network interface of the mobile device; and wirelessly transmitting the location/identification message to a communication network from the mobile device.

Implementations of such a method may include one or more of the following features. The location/identification message is produced in response to receipt of a threshold number of the network offer messages at the mobile device since a most-recent location/identification message was produced by the mobile device. The location/identification message is produced in response to the network offer message being associated with a different network than a network associated with a previous network offer message corresponding to a most-recent location message. The location/identification message is produced in response to receiving each network offer message. The method further includes inhibiting producing the location/identification message based on a network associated with the network offer message.

Another example of a mobile device includes: a network interface configured to send messages toward, and receive messages from, a communication network wirelessly; and a message module, communicatively coupled to the network interface, the message module being configured to produce and provide a location message to the network interface to be sent toward the communication network; where the location message contains information that enables at least one of determination or estimation of a location of the mobile device and identification of the mobile device; where the message module is configured to produce the location message based on a network communication message received at the mobile device through the network interface; and where the network interface and the message module are integrated such that a communication link between the network interface and the message module is substantially inaccessible.

Implementations of such a device may include one or more of the following features. The network interface and the message module are embedded into a motherboard of the device. The message module comprises a network interface card configured to produce the location message based on a network offer message received at the mobile device. The network interface card is configured to produce the location message based on a DHCP offer message received at the mobile device. The network interface card is configured to produce the location message in response to receipt of the network offer message. The network interface card is configured to produce the location message in response to receipt of a fixed quantity of the network offer messages received at the mobile device since a most-recent location message was produced by the message module. The network offer message comprises at least one IPv6 packet. The message module is configured to produce the location message based on a network associated with the network communication message. The location message includes at least one of satellite positioning system information, telecommunication cell information, or local wireless access point information.

Another example of a mobile device includes: a motherboard comprising: processing means; network communication means, communicatively coupled to the processing means, for wirelessly receiving network offer messages and for wirelessly transmitting a location message toward a communications network addressed to a predetermined destination; and message means, communicatively coupled to the network communication means, for producing the location message; where the network communication means and the message means are embedded in the motherboard such that removal of the network communication means and the message means is impractical; where a location of the mobile device can be at least one of determined or estimated from the location message; and where an identity of the mobile device can be determined from the location message.

Implementations of such a device may include one or more of the following features. The message means are configured to produce the location message based on a network offer message received at the mobile device by the network communication means. The message means are configured to produce the location message in response to receipt of a threshold number of the network offer messages at the mobile device since a most-recent location message was produced. The message means are configured to produce the location message in response to the network offer message being associated with a different network than a network associated with a previous network offer message corresponding to a most-recent location message produced by the message means.

Items and/or techniques described herein may provide one or more of the following capabilities, as well as other capabilities not mentioned. Wireless communication devices may be located autonomously. Security mechanisms for wireless communication devices may be more tamper-proof than previous mechanisms. A security mechanism can be embedded in a network interface to provide tracking information to the network interface without using an accessible communication line to make defeating the security mechanism inordinately difficult and/or inordinately detrimental to the functionality and/or value of the wireless device in which the security mechanism resides. A security mechanism can be provided for providing location information for a mobile device where the security mechanism is independent of the OS and BIOS of the mobile device such that disabling, removing, modifying, or replacing either of these will not affect the device's ability to provide location information. Further, it may be possible for an effect noted above to be achieved by means other than that noted, and a noted item/technique may not necessarily yield the noted effect.

### BRIEF DESCRIPTION OF THE DRAWINGS

FIG. 1 is simplified diagram of portions of a telecommunications system.

FIG. 2 is a block diagram of components of a mobile telecommunication device shown in FIG. 1.

FIG. 3 is a block flow diagram of a process of tracking the mobile telecommunication device shown in FIG. 2

FIG. 4 is a block flow diagram of a process of producing a location/identification message.

FIG. 5 is a block diagram of components of an alternative mobile telecommunication device.

### DETAILED DESCRIPTION

Techniques are provided for providing information associated with a mobile device to determine the device's identity and location. A network interface is configured to provide a location message with identification and location information to a predetermined destination. The network interface can be a network interface card. The location information can be obtained through a GPS system of the mobile device, by processing wireless LAN or cellular network information, by processing messages incoming to the mobile device, or by processing other information available to the network interface from which the device's location can be determined or estimated. For example, a network interface card (NIC), implemented in hardware and not using the OS or BIOS of the mobile device, monitors incoming DHCP (dynamic host configuration protocol) offer packets (intended for this mobile device or another mobile device), uses information in a DHCP offer packet to determine where to initially send a location message (e.g., a first network hop), to determine how to format the location message to enter the local network, and to produce the location message associated with a location of the mobile device, and sends the location message to a predetermined destination. The location message also identifies the mobile device, although this information may be derived from information not contained in the DHCP offer packet.

The network interface can send a location message based on various criteria. For example, the location message can be provided upon receipt of every DHCP offer packet, in response to receipt of every Nth DHCP offer packet, in response to a local network being other than a home network of the device, in response to the local network changing, etc.

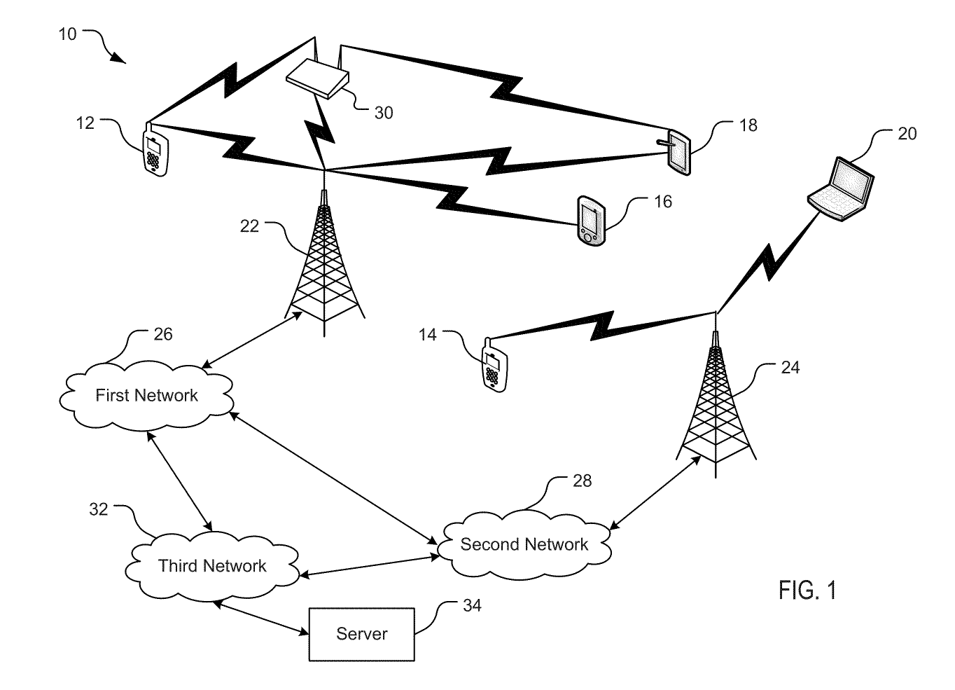

Referring to FIG. 1, a telecommunication system 10 includes mobile devices 12, 14, 16, 18, 20, base stations 22, 24, communication networks 26, 28, 32, a wireless access point (WAP) 30, and a server 34. The mobile devices 12, 14, 16, 18, 20 can be any of a variety of devices, here the devices 12, 14 being mobile phones, the device 16 being a personal digital assistant (PDA), the device 18 being a tablet computer, and the device 20 being a laptop computer. Other types of devices may be used and these examples are not exhaustive. The mobile devices 12, 14, 16, 18, 20 and the base stations 22, 24 are configured for bi-directional communication with each other, and the devices 12, 14, 16, 18, 20 and the WAP 30 are also configured for bi-directional communication with each other (although FIG. 1 shows only some of the possible communication links). The two networks 26, 28 may be configured to communication via the base stations 26, 28 using the same or different radio technologies to provide service to mobile devices 12, 14, 16, 18, 20. Such radio technologies include, for example, 2G, 3G, or 4G technologies such as Universal Terrestrial Radio Access Network (UTRAN), GSM EDGE (Enhanced Data rates for GSM Evolution) Radio Access Network (GERAN) circuit switched domain access, CDMA (Code Division Multiple Access) 1x RTT (also referred to as CDMA2000 1X), or long-term evolution based (LTE-based) EUTRAN (evolved UMTS Terrestrial Radio Access Network).

The networks 26, 28 have different topologies. The networks 26, 28 have different interconnections and different identifications, although the networks may provide service to the same location. The networks 26, 28 are distinctly identifiable such that one network can be distinguished from the other.

The networks 26, 28 are configured to communicate bi-directionally with each other, with the network 32 (e.g., the Internet), and with further networks not shown. One or both of the networks 26, 28 is preferably connected to the Internet or other global network. The inter-network communication allows communications from the mobile devices 12, 14, 16, 18, 20 to be disseminated or passed on, e.g., to any network-connected destination/address, e.g., globally.

The server 34 is connected to the network 32, and thus indirectly connected to the networks 26, 28. The server 34 could also be directly connected to the network 26 and/or the network 28. The server 34 is associated with the mobile device 12, and provides a mechanism for tracking the mobile device 12 as discussed further below.

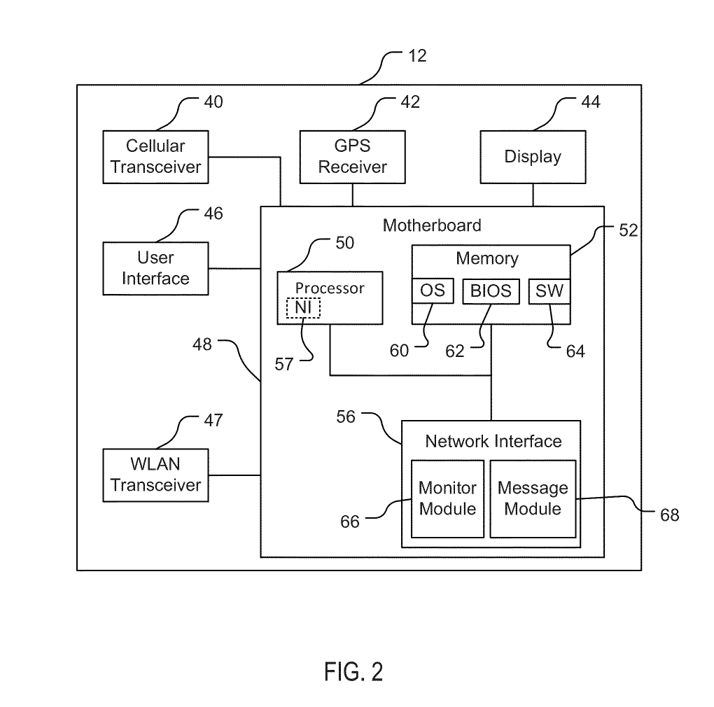

Referring to FIG. 2, an example of components of a mobile telecommunication device is shown. Here, the mobile device 12 includes a cellular transceiver 40, a satellite positioning system (SPS) receiver, here a global positioning system (GPS) receiver 42, a display 44, a user interface 46, a wireless local area network (WLAN) transceiver 47, and a motherboard 48 including a processor 50, memory 52, and a network interface 56. The display 44 is a liquid-crystal display (LCD) (e.g., a thin-film transistor (TFT) display), although other forms of displays are acceptable. The user interface 46 here includes a keyboard (although this may be omitted, e.g., where the display 44 is a touch-sensitive display), a microphone, a speaker, and a camera. The processor 50 is preferably an intelligent device, e.g., a personal computer central processing unit (CPU) such as those made by Intel® Corporation or AMD®, a microcontroller, an application specific integrated circuit (ASIC), etc. The memory 52 includes random access memory (RAM) and read-only memory (ROM). The memory 52 stores processor-readable, processor-executable software code 64 containing instructions for controlling the processor 50 to perform desired functions of the mobile device 12. The memory 52 further includes operating system (OS) 60 code and basic input/output system 62 code. The OS 60 is stored in ROM and the BIOS is stored in volatile memory, e.g., flash memory, and/or in non-volatile ROM.

The network interface 56 is integrated into the motherboard 48. The network interface 56 is preferably a hardware network interface card that is embedded in the motherboard 48 such that removal of the network interface 56 is very difficult/impractical, if not impossible, without damaging the motherboard 56. For example, components of the network interface 56 are integrated and mixed with other components of the motherboard 48 such that the interface 56 is not a distinct unit and cannot be separated from the motherboard 56 without removing or hindering operation of components of other functional units of the motherboard 48. Alternatively, the network interface may be more integrated/embedded into the motherboard 48 than this. For example, a network interface 57 may be integrated into the processor 50. The network interface 57 can be configured with the same functionality discussed herein with respect to the network interface 56.

The network interface 56 includes a monitor module 66 and a message module 68. The monitor module 66 is preferably implemented in hardware that is independent of the OS 60 and the BIOS 62 and is integrated with the network interface hardware such that the monitor module 66 is substantially inaccessible. Removal and/or reinstallation of the OS 60 and/or the BIOS 62 will not affect the operation of the monitor module 66 discussed herein. The module 66 does not rely on (e.g., communicate with or use information from) the OS 60 or the BIOS 62 to provide the functions described. The module 66 is configured with the network interface 56 such that disabling or removing the module 66 is impractical (e.g., difficult and/or expensive), if not impossible, without negatively impacting, e.g., disabling, the network interface functions of the network interface 56. The module 66 is preferably contained within a sealed housing of the interface 56, does not use a wireless communication link to other portions of the device 12, is not accessible without physically dismantling/damaging a housing, the interface 56, and/or the module 66, and does not use a trace line for communicating with other portions of the interface 56. The module 66 could be implemented using processor-readable, software stored in memory of the module 66 and executed by a processor of the module 66. Further, the monitor module 66 could be implemented in another network access device, e.g., an evolution data optimized (EVDO) card, a wireless connectivity module, etc., instead of or in addition to being implemented in the interface 56, which may be a classic Internet connection.

The monitor module 66 is configured to provide information regarding the mobile device's identity and location. In at least some implementations, the module 66 communicates with the cellular transceiver 40, the GPS receiver 42, and/or the WLAN transceiver 47 to determine location information. The cellular transceiver 40 can provide cellular communication data (e.g., signal strength, nearby base station identities, etc.) from which, alone or in combination with other information, the location or a location estimate of the mobile device 12 can be determined. The GPS receiver 42 can provide location information such as latitude and longitude of the mobile device 12. Further, the WLAN transceiver can provide information such as signal strength from access points, access point identities, etc., from which the location or a location estimate of the mobile device 12 can be determined, or that can supplement other information from which, in combination, the location of location estimate of the device 12 can be determined.

The module 66 is configured to monitor received communication signals received by the device 12. The module 66 monitors these communications for information for use in accessing a network. For example, the system looks for network offer packets intended for the mobile device 12 or another destination. Here, the module 66 monitors communications for dynamic host configuration protocol (DHCP) offer packets that provide information for connecting to a network. Knowing the format (“shape”) of the communications, the module 66 can analyze the communications, here DHCP offer packets, and collect information from the communications in order to form an outgoing message to the network. Other types of communications may be monitored and used, e.g., internet protocol version 6 (IPv6) router discovery messages instead of or in addition to DHCP offer packets.

The message module 68 can form messages that the network interface 56 sends toward a network. The message module 68 uses information from the offer packet(s), and preferably location information, to produce and send a network message toward a predetermined destination, e.g., the server 34, through the network interface 56. The message module 68 analyzes one or more offer packets to determine where to initially send a location message (e.g., a first network hop), and to determine how to format the location message to enter the local network. The network interface 56 can send environmental information that the interface 56 has access to, e.g., 802.11 WAP information, which often has good related location information, in order to help with locating the device 12. Different implementations of the message module 68 may provide different forms of location information, such as latitude and longitude coordinates, range(s) from one or more base stations and/or one or more wireless access points, a local serving base station and/or access point identity and/or location, a local network identity, etc. The predetermined destination is preferably encoded in the message module 68 during manufacture such that the destination is substantially inaccessible and not re-writable. The message from the message module 68 also identifies the mobile device 12.

Implementations of the message module 68 can produce and/or send the network messages in response to one or more of the following triggers. The message module 68 could prepare and/or send the network message based on network topology, e.g., in response to the network changing or a determination that the local network is not a home network, or that the local network is one of a specified list of networks. Alternatively, the message module 68 could decide not to send the network message based on the topology, e.g., if the local network is one of list of networks. The module 68 could respond to a specific received request for the mobile device's location, e.g., sent by an authorized source in response to the mobile device 12 being reported as lost or stolen. The module 66 send a network message upon receipt of a certain number of packets, such as every N^{th} DHCP offer packet received. The module 66 could send the network message periodically, e.g., every X minutes. Still other triggers are possible. The network message is sent to the network without requiring a request by or approval of a user of the mobile device 12. Preferably, the module 68 sends the network message without providing the user with any indication that a message is being sent.

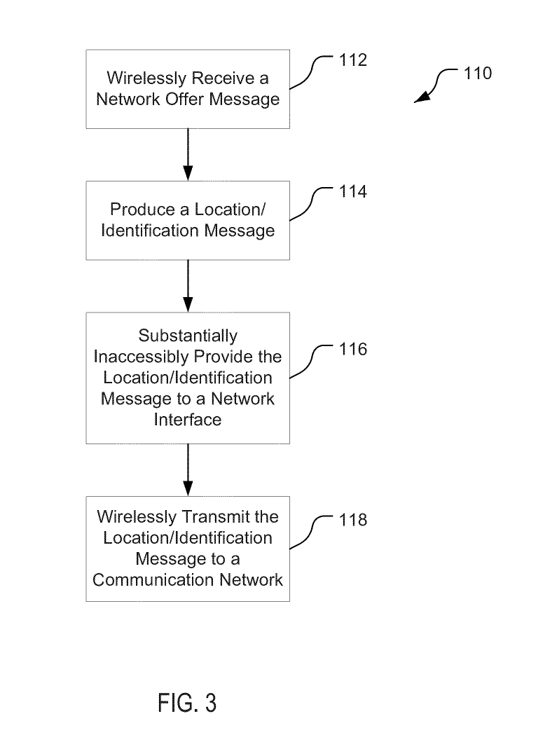

Referring to FIG. 3, with further reference to FIGS. 1-2, a process 110 of providing mobile device tracking information includes the stages shown. The process 110 is, however, an example only and not limiting. The process 110 can be altered, e.g., by having stages added, removed, rearranged, combined, and/or performed concurrently.

At stage 110 the mobile device 12 wirelessly receives a network offer message. The network offer message may be directed toward the mobile device 12 or another device. The offer message contains information from which an outbound message can be produced for transmission to a local network, e.g., the network 26, 28, e.g., via one of the base stations 22, 24 and/or the wireless access point 30. The monitor module 66 obtains the offer packet.

At stage 114, the message module 68 produces a location/identification message. The module 68 determines where to initially send a location message (e.g., a first network hop), determines how to format the location message to enter the local network, pulls information from the offer packet to use in the location/identification message to provide location information for the mobile 12. The module 68 also includes identification information in the message to identify the mobile device 12.

At stage 116, the module 68 substantially inaccessibly provides the location/identification message to the network interface 56. The message is provided to the network interface 56 without using wireless transmissions and without using wired transmissions over a hard connection that is readily accessible, e.g., an open trace on a circuit board that could be severed.

At stage 118, the network interface 56 wirelessly transmits the location/identification message to a communication network. The network interface 56 sends the network message to a local network, e.g., the network 26, 28, for routing to the address of a predetermined destination, here the server 34, provided by the message module 68. The predetermined destination will likely (as here), but not necessarily, have as its local network a network other than the networks 26, 28.

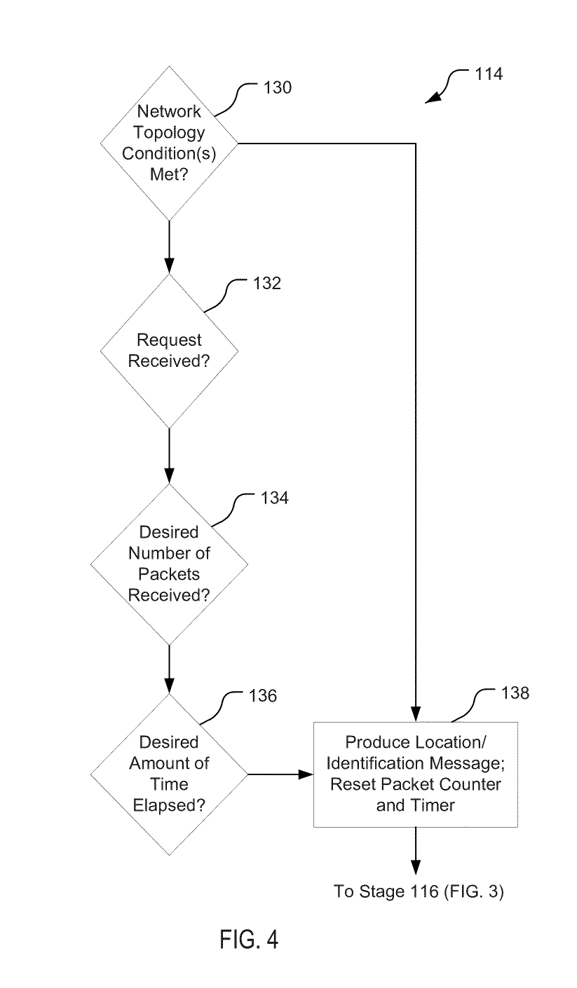

Referring to FIG. 4, with further reference to FIGS. 1-3, the stage 114 shown in FIG. 3 of producing the location/identification message includes the stages shown. The process 114 is, however, an example only and not limiting. The process 114 can be altered, e.g., by having stages added, removed, rearranged, combined, and/or performed concurrently. For example, while the process 114 is shown and discussed below as having several possible triggers for preparing the network message, fewer than all, e.g., one, of these triggers may be used, or one or more other triggers may be used instead of in addition to the stages shown, or in place of one or more of the stages shown.

At stage 130, the message module 68 determines whether one or more network topology conditions are met. For example, if the local network changes, the local network is one of a predetermined set of triggering networks, the local network is not the mobile device's home network, and the local network is not one of a predetermined set of non-triggering networks, then the process 114 proceeds to stage 138.

At stage 132, the message module 68 determines whether a request for a location/identification message has been received. The request could be received from the server 34 after the owner of the mobile device 12 reports the mobile device lost or stolen. If such a request has been received, then the process 114 proceeds to stage 138 and proceeds to stage 134 otherwise.

At stage 134, the module 68 determines whether a desired number of offer packets have been received since the last time that a location/identification message was sent. If a desired number of offer packets have been received (e.g., a counter, C, of received offer packets equals N, or C is greater than M), then the process 114 proceeds to stage 138. If a desired number of packets has not yet been received, then the process 114 proceeds to stage 136.

At stage 136, the module 68 determines whether a desired amount of time has passed since the last location/identification message was sent. Here, the module 68 determines whether a value of a timer, that tracks the time since the last message was sent, exceeds a time threshold. If so, then the process 114 proceeds to stage 138 and otherwise returns to stage 130.

At stage 138, the message module 68 produces the location/identification message. The module 68 compiles information regarding the location and identification of the mobile device 12 and composes the location/identification message. The message is addressed to the server 34. The module 68 also resets the counter C (e.g., to zero) for the number of offer packets received since the last location/identification message was sent, and resets the timer that tracks the time since the last location/identification message was sent.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). A wireless communication network does not have all communications transmitted wirelessly, but is configured to have at least some communications transmitted wirelessly.

Other examples and implementations are possible in accordance with, and in view of, the discussion herein. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

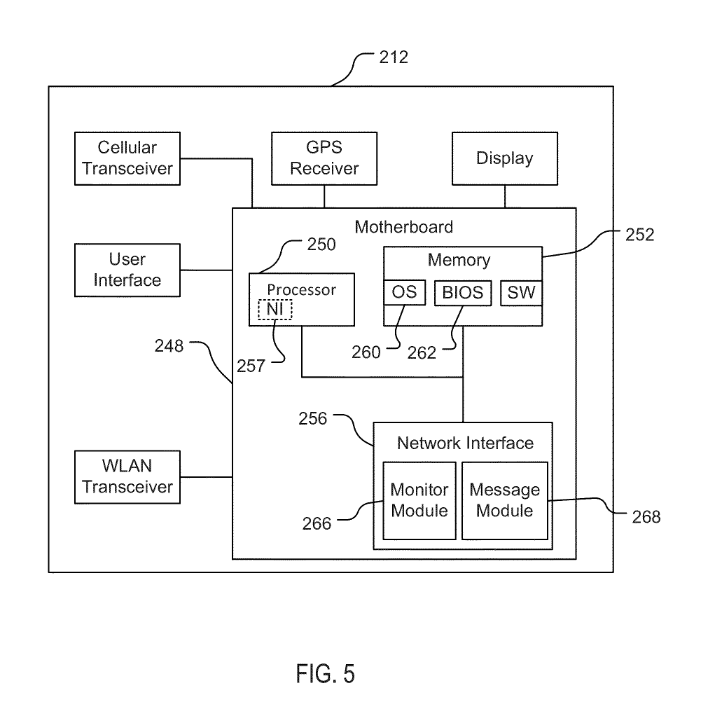

Further, a network interface could be used that is substantially inaccessible, yet not independent of the OS and/or the BIOS. Referring to FIG. 5, a mobile device 212 includes a motherboard 248. The motherboard 248 includes a processor 250, memory 252, and a network interface 256. The network interface 256 includes a monitor module 266 and a message module 268 configured to perform functions similar to those described above with respect to the monitor module 66 and the message module 68, except that the modules 266, 268 use at least one of an OS 260 and/or a BIOS 262 of the memory 252. As with the interface 56 shown in FIG. 2, the network interface 256 is integrated into the motherboard 248. The network interface 256 is preferably a hardware network interface card that is embedded in the motherboard 248 such that removal of the network interface 256 is very difficult/impractical, if not impossible, without damaging the motherboard 256. For example, components of the network interface 256 are integrated and mixed with other components of the motherboard 248 such that the interface 256 is not a distinct unit and cannot be separated from the motherboard 256 without removing or hindering operation of components of other functional units of the motherboard 248. Alternatively, the network interface may be more integrated/embedded into the motherboard 248 than this. For example, a network interface 257 may be configured to perform function described with respect to the interface 256, but is integrated into the processor 250. The interface 256 (or 257) can perform functions similar to those discussed above similar to the interface 56 (or 57), and implement methods similar to those discussed with respect to FIGS. 3-4.

Further, more than one invention may be disclosed.

What is claimed is:

1. A mobile device comprising:
a network interface configured to send messages toward, and receive messages from, a communication network wirelessly; and
a message module, communicatively coupled to the network interface, independent of an operating system of the mobile device, and independent of a basic input/output system (BIOS) of the mobile device, the message module being configured to produce and provide a location message to the network interface to be sent toward the communication network;
wherein the location message contains information that enables at least one of determination or estimation of a location of the mobile device and identification of the mobile device;
wherein the message module is configured to provide the location message to the transmitter without use of the operating system or the BIOS; and
wherein the message module is configured to produce the location message based on a network communication message received at the mobile device through the network interface.

2. The device of claim 1 wherein the message module comprises a network interface card configured to produce the location message based on a network offer message received at the mobile device.

3. The device of claim 2 wherein the network interface card is configured to produce the location message based on a DHCP offer message received at the mobile device.

4. The device of claim 2 wherein the network interface card is configured to produce the location message in response to receipt of the network offer message.

5. The device of claim 4 wherein the network interface card is configured to produce the location message in response to receipt of a fixed quantity of the network offer messages received at the mobile device since a most-recent location message was produced by the message module.

6. The device of claim 2 wherein the network offer message comprises at least one IPv6 packet.

7. The device of claim 1 wherein the message module is configured to produce the location message based on a network associated with the network communication message.

8. The device of claim 1 wherein the location message includes at least one of satellite positioning system information, telecommunication cell information, or local wireless access point information.

9. The device of claim 1 wherein the message module consists of processing hardware and the network interface and the message module are integrated such that a communication link between the network interface and the message module is substantially inaccessible.

10. A mobile device comprising:
network communication means for wirelessly receiving network offer messages and for wirelessly transmitting a location message toward a communications network addressed to a predetermined destination; and
message means for producing the location message, the message means and network communication means module being configured such that the location message is substantially inaccessible during communication from the message means to the network communication means;
wherein a location of the mobile device can be at least one of determined or estimated from the location message; and
wherein an identity of the mobile device can be determined from the location message.

11. The device of claim 10 wherein the message means are for producing the location message independently of an operating system (OS) of the mobile device, and independently of a basic input/output system (BIOS) of the mobile device.

12. The device of claim 10 wherein the message means are configured to produce the location message based on a network offer message received at the mobile device by the network communication means.

13. The device of claim 12 wherein the message means are configured to produce the location message in response to receipt of a threshold number of the network offer messages at the mobile device since a most-recent location message was produced.

14. The device of claim 12 wherein the message means are configured to produce the location message in response to the network offer message being associated with a different network than a network associated with a previous network offer message corresponding to a most-recent location message produced by the message means.

15. A method of providing mobile device tracking information, the method comprising:
wirelessly receiving a network offer message at a mobile device;
producing a location/identification message, from which an identity of the mobile device can be determined and a location of the mobile device can be at least one of determined or estimated, independently of an operating system and a basic input/output system of the mobile device;
substantially inaccessibly providing the location/identification message to a network interface of the mobile device; and
wirelessly transmitting the location/identification message to a communication network from the mobile device.

16. The method of claim 15 wherein the location/identification message is produced in response to receipt of a threshold number of the network offer messages at the mobile device since a most-recent location/identification message was produced by the mobile device.

17. The method of claim 15 wherein the location/identification message is produced in response to the network offer message being associated with a different network than a network associated with a previous network offer message corresponding to a most-recent location message.

18. The method of claim 15 wherein the location/identification message is produced in response to receiving each network offer message.

19. The method of claim 15 further comprising inhibiting producing the location/identification message based on a network associated with the network offer message.

20. A mobile device comprising:
a network interface configured to send messages toward, and receive messages from, a communication network wirelessly; and
a message module, communicatively coupled to the network interface, the message module being configured to produce and provide a location message to the network interface to be sent toward the communication network;
wherein the location message contains information that enables at least one of determination or estimation of a location of the mobile device and identification of the mobile device;
wherein the message module is configured to produce the location message based on a network communication message received at the mobile device through the network interface; and
wherein the network interface and the message module are integrated such that a communication link between the network interface and the message module is substantially inaccessible.

21. The device of claim 20 wherein the network interface and the message module are embedded into a motherboard of the device.

22. The device of claim 20 wherein the message module comprises a network interface card configured to produce the location message based on a network offer message received at the mobile device.

23. The device of claim 22 wherein the network interface card is configured to produce the location message based on a DHCP offer message received at the mobile device.

24. The device of claim 22 wherein the network interface card is configured to produce the location message in response to receipt of the network offer message.

25. The device of claim 24 wherein the network interface card is configured to produce the location message in response to receipt of a fixed quantity of the network offer messages received at the mobile device since a most-recent location message was produced by the message module.

26. The device of claim 22 wherein the network offer message comprises at least one IPv6 packet.

27. The device of claim 20 wherein the message module is configured to produce the location message based on a network associated with the network communication message.

28. The device of claim 20 wherein the location message includes at least one of satellite positioning system information, telecommunication cell information, or local wireless access point information.

29. A mobile device comprising:
a motherboard comprising:
processing means;
network communication means, communicatively coupled to the processing means, for wirelessly receiving network offer messages and for wirelessly transmitting a location message toward a communications network addressed to a predetermined destination; and
message means, communicatively coupled to the network communication means, for producing the location message;
wherein the network communication means and the message means are embedded in the motherboard such that removal of the network communication means and the message means is impractical;
wherein a location of the mobile device can be at least one of determined or estimated from the location message; and
wherein an identity of the mobile device can be determined from the location message.

30. The device of claim 29 wherein the message means are configured to produce the location message based on a network offer message received at the mobile device by the network communication means.

31. The device of claim 30 wherein the message means are configured to produce the location message in response to receipt of a threshold number of the network offer messages at the mobile device since a most-recent location message was produced.

32. The device of claim 30 wherein the message means are configured to produce the location message in response to the network offer message being associated with a different network than a network associated with a previous network offer message corresponding to a most-recent location message produced by the message means.
